(19) United States
(12) Patent Application Publication
(10) Pub. No.: US 2024/0319339 A1
(43) Pub. Date: Sep. 26, 2024

(54) TECHNIQUES FOR ASSEMBLING "LIDAR ON A CHIP" TO MINIMIZE MECHANICAL VOLUME

(71) Applicant: AEVA, INC., Mountain View, CA (US)

(72) Inventors: Cameron Howard, Bend, OR (US); Bradley Scot Levin, San Jose, CA (US)

(21) Appl. No.: 18/125,620

(22) Filed: Mar. 23, 2023

(51) Int. Cl. G01S 7/481; G01S 7/4915; G01S 17/58

(52) U.S. Cl. CPC G01S 7/481; G01S 7/4915; G01S 17/58

(57) ABSTRACT

An FMCW LiDAR system comprises an optical source to transmit an optical beam towards a target. The LiDAR system comprises a first layer, folding optics and a second layer. The first layer comprises a silicon photonics chip coupled to an electrical power source to transmit electrical power to optical components resident on a second layer, and a plurality of different interfaces to couple the silicon photonics chip to the optical components. The folding optics is to receive the optical beam from the first layer and transmit the optical beam to the second layer. The second layer is disposed directly over the first layer. The second layer comprises the optical components including an LO to general an LO signal, and a receiver to mix a target return signal and the LO signal to extract at least one of range or velocity information related to the target.

### TECHNICAL FIELD

The present disclosure relates generally to light detection and ranging (LiDAR) systems, and more particularly to techniques for assembling “LiDAR on a chip” to minimize mechanical volume.

### BACKGROUND

A FMCW LiDAR system mixes a local oscillator (LO) signal (e.g., LO beam) with a target return signal (e.g., target beam), which is the reflected light from a target, to extract range or velocity information. It is important for a LiDAR system to have a small overall mechanical volume. However, it is difficult to place all the components of the LiDAR system in a small XY form factor. It is also challenging to handle electrical power transmission and thermal management in the LiDAR system.

### SUMMARY

The present disclosure describes various examples of assembly techniques in a FMCW LiDAR system.

In some examples, disclosed herein are a LIDAR module of a LiDAR system and techniques of assembling the LiDAR module to be within the XY form factor of the silicon photonics chip. The optical components are directly mounted over the silicon photonics chip to assemble “LiDAR on a chip” in the LiDAR system. The optical components may include an optical amplifier, a beam splitter, a dichroic filter, an isolator, a local oscillator, etc. In addition to having the optical waveguides, the silicon photonics chip is capable of carrying electrical current to transmit electrical power to the optical components. The material properties of the silicon photonics chip also provide heat spreading benefits for heat generating components. By directly mounting the optical components over the silicon photonics chip, the overall volume consumed by the LiDAR module can be contained within the XY form factor of the silicon photonics chip. In this fashion, the thermal performance of the LiDAR system is also improved.

In some examples, a frequency modulated continuous wave (FMCW) LiDAR system is disclosed herein. The FMCW LiDAR system comprises an optical source to transmit an optical beam towards a target. The FMCW LiDAR system comprises a first layer, folding optics and a second layer. The first layer comprises a silicon photonics chip coupled to an electrical power source to transmit electrical power to one or more optical components resident on a second layer, and a plurality of different interfaces to couple the silicon photonics chip to the one or more optical components. The folding optics is to receive the optical beam from the first layer and transmit the optical beam to the second layer. The second layer is disposed directly over the first layer. The second layer comprises the one or more optical components. The one or more optical components comprises a local oscillator (LO) to general an LO signal, and a receiver to mix a target return signal received from the target based on the optical beam and the LO signal to extract at least one of range or velocity information related to the target.

In some examples, a method of FMCW LiDAR is disclosed herein. The method includes transmitting an optical beam towards a target. The method includes coupling an electrical power source, by a first layer including a silicon photonics chip, to transmit electrical power to one or more optical components resident on a second layer, where the second layer disposed directly over the first layer. The method includes coupling the silicon photonics chip, by a plurality of different interfaces to the one or more optical components. The method includes receiving the optical beam from the first layer and transmitting the optical beam to the second layer by folding optics. The method includes generating an LO signal, by an LO on the second layer. The method includes mixing, by a receiver, a target return signal received from the target based on the optical beam and the LO signal to extract at least one of range or velocity information related to the target.

It should be appreciated that, although one or more embodiments in the present disclosure depict the use of point clouds, embodiments of the present disclosure are not limited as such and may include, but are not limited to, the use of point sets and the like.

These and other aspects of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and examples, should be viewed as combinable unless the context of the disclosure clearly dictates otherwise.

It will therefore be appreciated that this Summary is provided merely for purposes of summarizing some examples so as to provide a basic understanding of some aspects of the disclosure without limiting or narrowing the scope or spirit of the disclosure in any way. Other examples, aspects, and advantages will become apparent from the following detailed description taken in conjunction with the accompanying figures which illustrate the principles of the described examples.

### BRIEF DESCRIPTION OF THE DRAWINGS

For a more complete understanding of various examples, reference is now made to the following detailed description taken in connection with the accompanying drawings in which like identifiers correspond to like elements:

FIG. 1 illustrates a LiDAR system according to example implementations of the present disclosure.

FIG. 2 is a time-frequency diagram illustrating an example of FMCW LIDAR waveforms according to embodiments of the present disclosure.

FIG. 3A is a diagram illustrating a side view of an example of an integrated module of a LiDAR system according to embodiments of the present disclosure.

FIG. 3B is a diagram illustrating a top view of the example of the integrated module of the LiDAR system in FIG. 3A according to embodiments of the present disclosure.

FIG. 3C is a diagram illustrating a cross section view of an example of an optical component in the integrated module of the LiDAR system in FIG. 3A according to embodiments of the present disclosure.

FIG. 3D is a diagram illustrating a side view of another example of an integrated module of a LiDAR system according to embodiments of the present disclosure.

FIG. 3E is a diagram illustrating a side view of yet another example of an integrated module of a LiDAR system according to embodiments of the present disclosure.

FIG. 4 is a flow diagram illustrating an example of a method of operating an integrated module of a LiDAR system according to embodiments of the present disclosure.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

The described LiDAR systems herein may be implemented in any sensing market, such as, but not limited to, transportation, manufacturing, metrology, medical, virtual reality, augmented reality, and security systems. According to some embodiments, the described LiDAR system may be implemented as part of a front-end of frequency modulated continuous-wave (FMCW) device that assists with spatial awareness for automated driver assist systems, or self-driving vehicles.

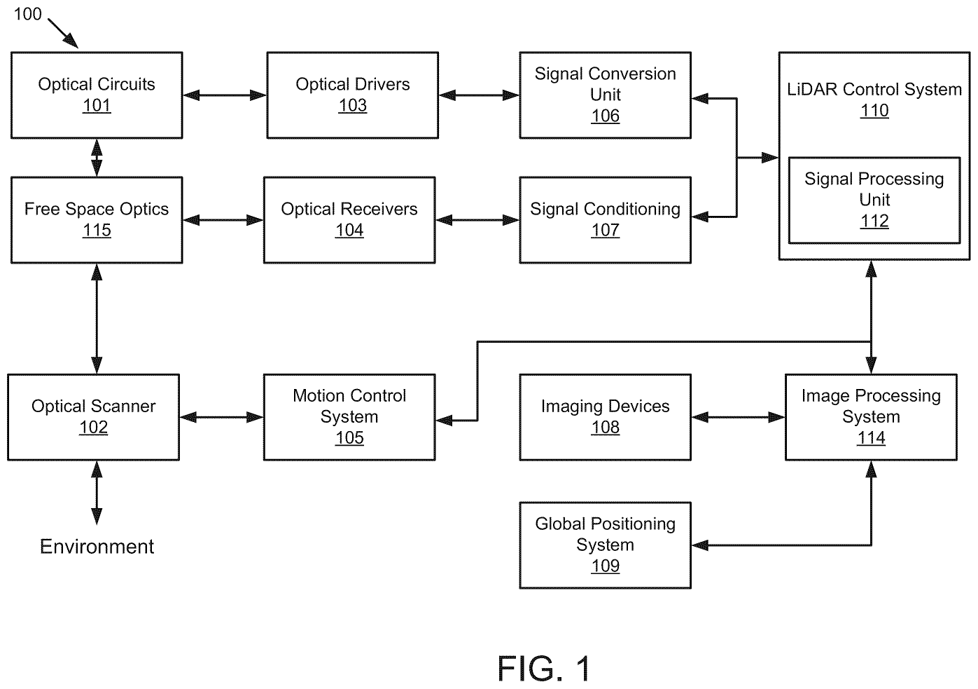

FIG. 1 illustrates a LiDAR system 100 according to example implementations of the present disclosure. The LiDAR system 100 includes one or more of each of a number of components, but may include fewer or additional components than shown in FIG. 1. According to some embodiments, one or more of the components described herein with respect to LiDAR system 100 can be implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles.

In some examples, the LiDAR system 100 includes an optical scanner 102 that includes one or more scanning mirrors that are rotatable along an axis (e.g., a slow-moving-axis) that is orthogonal or substantially orthogonal to the fast-moving-axis of the diffractive element to steer optical signals to scan a target environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coating window or the like.

To control and support the optical circuits 101 and optical scanner 102, the LiDAR system 100 includes LiDAR control systems 110. The LiDAR control systems 110 may include a processing device for the LiDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LiDAR control systems 110 may include a signal processing unit 112 such as a digital signal processor (DSP). The LiDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LiDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LiDAR control systems 110 to signals interpretable by the galvanometers in the optical scanner 102. In some examples, a motion control system 105 may also return information to the LiDAR control systems 110 about the position or operation of components of the optical scanner 102. For example, an analog-to-digital converter may in turn convert information about the galvanometers' position or angle to a signal interpretable by the LIDAR control systems 110.

The LiDAR control systems 110 are further configured to analyze incoming digital signals. In this regard, the LiDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LiDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LiDAR control systems 110. In some examples, the signals from the optical receivers 104 may be subject to signal conditioning by signal conditioning unit 107 prior to receipt by the LiDAR control systems 110. For example, the signals from the optical receivers 104 may be provided to an operational amplifier for amplification of the received signals and the amplified signals may be provided to the LIDAR control systems 110.

In some applications, the LiDAR system 100 may additionally include one or more imaging devices 108 configured to capture images of the environment, a global positioning system 109 configured to provide a geographic location of the system, or other sensor inputs. The LiDAR system 100 may also include an image processing system 114. The image processing system 114 can be configured to receive the images and geographic location, and send the images and location or information related thereto to the LiDAR control systems 110 or other systems connected to the LIDAR system 100.

In operation according to some examples, the LiDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LiDAR control systems 110. The LiDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LiDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

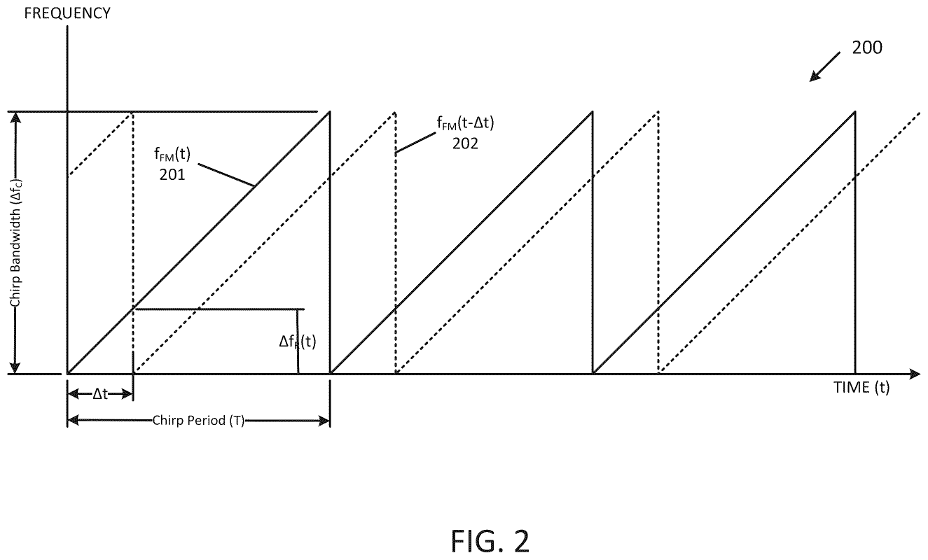

FIG. 2 is a time-frequency diagram 200 illustrating an example of FMCW LIDAR waveforms according to embodiments of the present disclosure. FIG. 2 illustrates an FMCW scanning signal 201 that can be used by a LiDAR system, such as system 100, to scan a target environment according to some embodiments. In one example, the FMCW scanning signal 201 labeled as f_{FM}(t), is a sawtooth waveform (sawtooth “chirp”) with a chirp bandwidth Δf_{C} and a chirp period T_{c}. The slope of the sawtooth is given as k=(Δf_{C}/T_{C}). FIG. 2 also depicts target return signal 202 according to some embodiments. Target return signal 202, labeled as f_{FM}(t−Δt), is a time-delayed version of the FMCW scanning signal 201, where Δt is the round trip time to and from a target illuminated by the FMCW scanning signal 201. The round trip time is given as Δt=2R/ν, where R is the target range and ν is the velocity of the optical beam, which is the speed of light c. The target range, R, can therefore be calculated as R=c(Δt/2). When the target return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

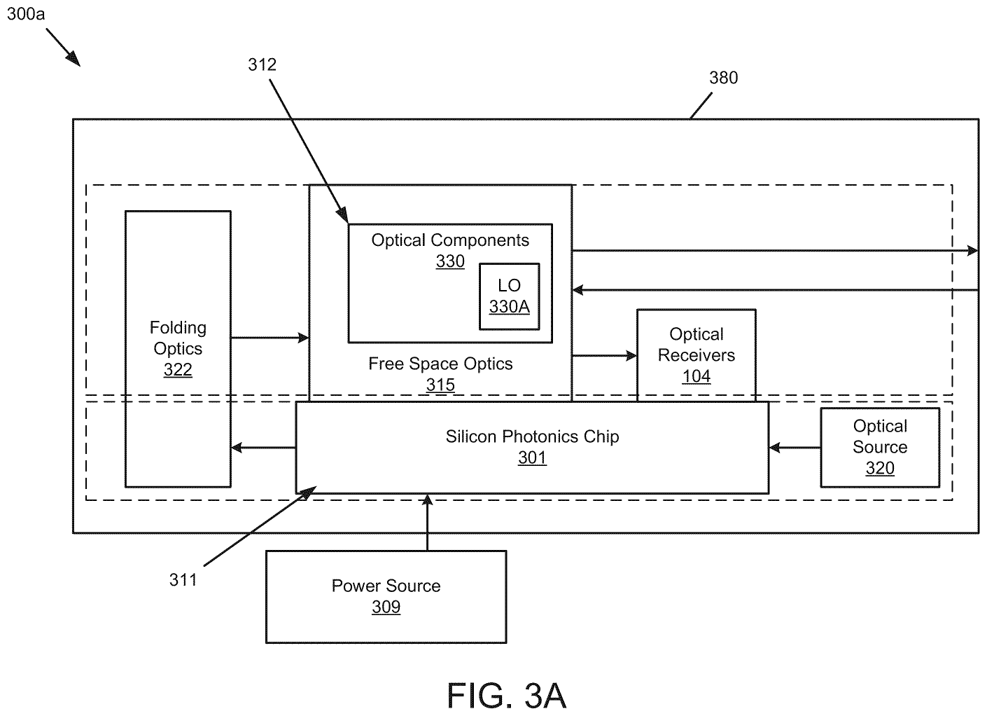

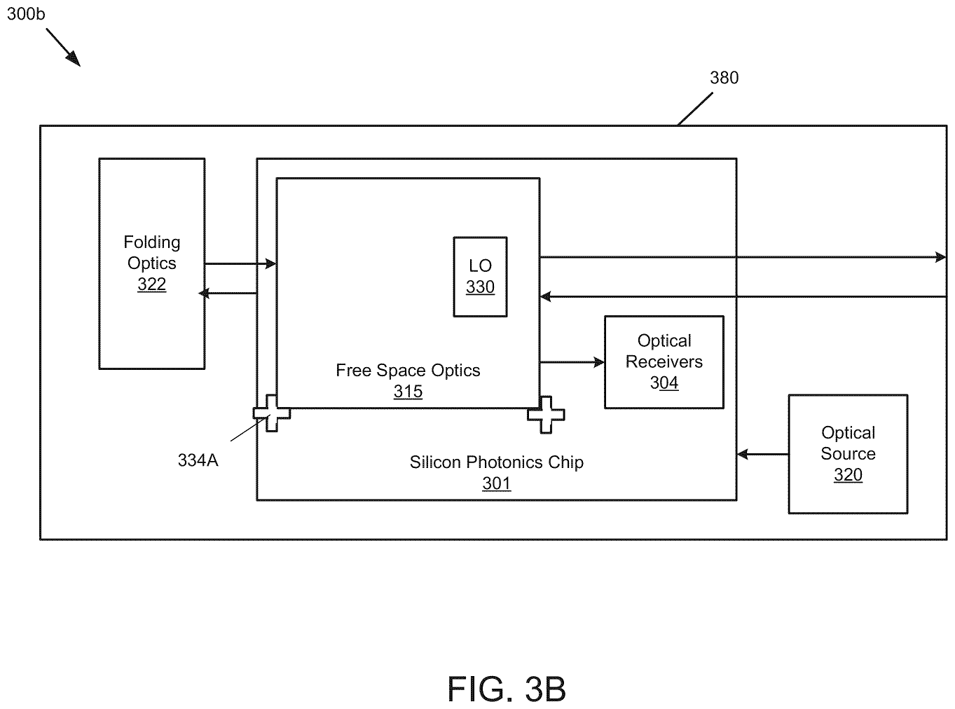

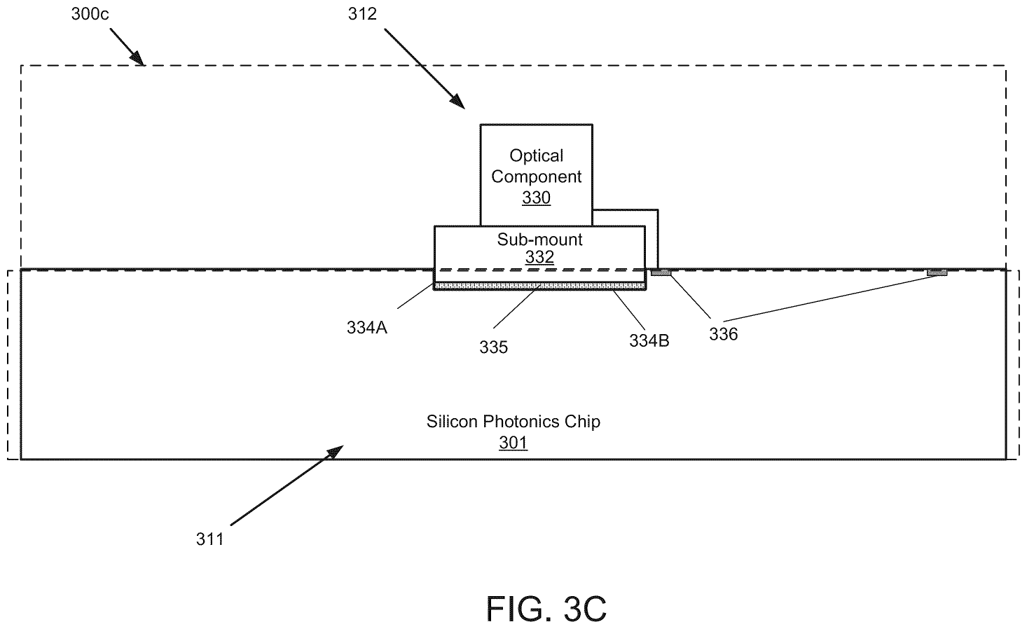

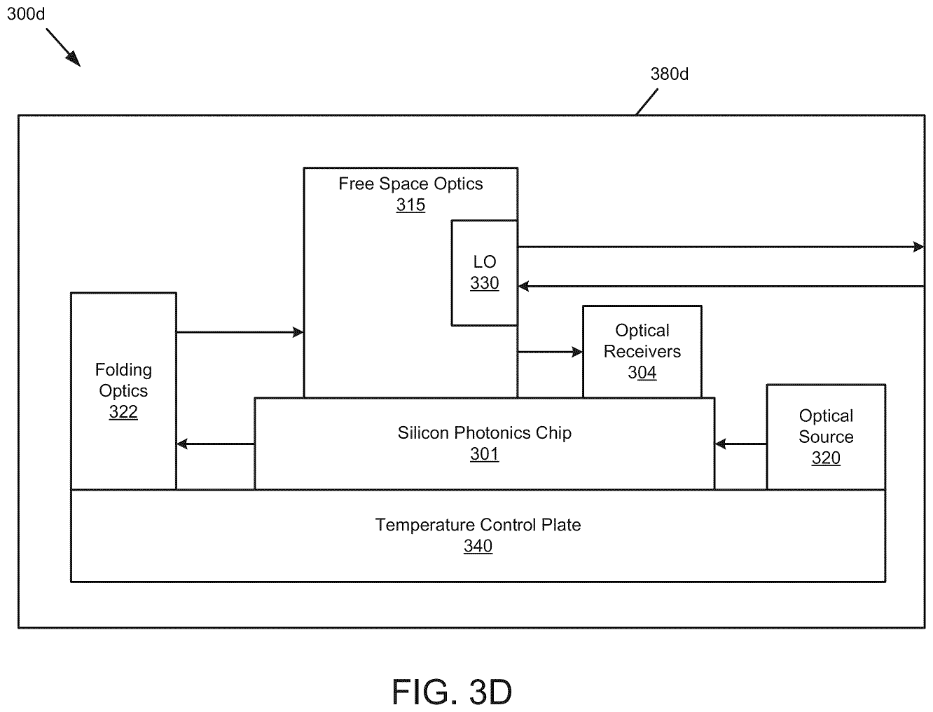

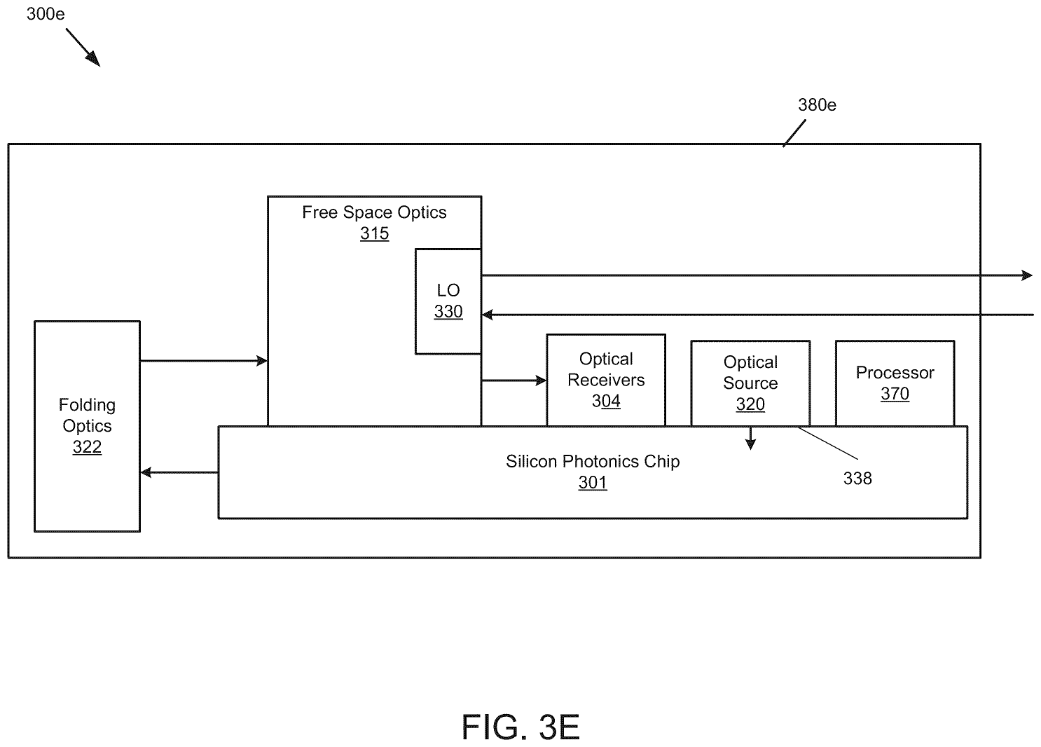

FIG. 3A is a diagram 300a illustrating a side view of an example of an integrated module 380 of a LiDAR system according to embodiments of the present disclosure. The LiDAR system may be the LIDAR system 100 described in connection with FIG. 1. It is challenging to place all the components of the LiDAR system in a small XY form factor, in order to have a small overall mechanical volume. It is also challenging to handle electrical power transmission and thermal management in the LiDAR system.

Referring to FIG. 3A, the integrated module 380 includes two layers, a first layer 311 and a second layer 312. The integrated module 380 further includes an optical source 320 to emit an optical beam and folding optics 322 to receive the optical beam from the first layer 311 and transmit the optical beam to the second layer 312. The first layer 311 includes a silicon photonics chip 301, which may implement functions of the optical circuits 101 as described in connection with FIG. 1. In some examples, the silicon photonics chip 301 may include optical waveguides to receive, transmit, guide and/or direct the optical beam. In some examples, the silicon photonics chip 301 may include a combination of active optical components and passive optical components. In some examples, the silicon photonics chip 301 may be coupled to an electrical power source 309. The silicon photonics chip 301 may carry electrical current to transmit electrical power to the second layer.

The second layer 312 is disposed directly over the first layer 311. The second layer 312 includes free space optics 315, which is similar to free space optics 115, as described in connection with FIG. 1. In some examples, the free space optics 315 may include one or more optical components 330 such as LO 330A, lenses, optical amplifiers, beam splitters/combiners, dichroic filters, isolators, etc. The free space optics 315 may also include taps, wavelength division multiplexers (WDM), polarization beam splitters (PBS), collimators, couplers or the like. In some examples, the one or more optical components 330 may include components to transform the polarization state and direct received polarized light to optical detectors using a PBS, for example. The one or more optical components 330 may further include a diffractive element to deflect optical beams having different frequencies at different angles. The one or more optical components 330 may include one or more optical waveguides to carry optical signals, and route and manipulate optical signals to appropriate input/output ports of the silicon photonics chip 301.

In some examples, the optical components 330 includes an LO 330A to generate an LO signal. The optical components 330 further includes an optical receiver 104. For example, as discussed above in connection with FIG. 1, the optical receiver 104 may measure the optical signal that carries information about the range and velocity of a target in the form of a beat frequency. The target return signal from the reflected optical beam of a target may be mixed with the LO signal from the LO 330A to extract at least one of range or velocity information related to the target.

The one or more optical components 330 are directly mounted over the silicon photonics chip 301 to assemble a “LiDAR on a chip” in the LiDAR system. The silicon photonics chip 301 may include different interfaces (not shown) to couple the silicon photonics chip 301 to the one or more optical components 330. The different interfaces may include mechanical interfaces, thermal interfaces, electrical interfaces and/or optical interfaces, which will be discussed in detail below. In addition to having the optical waveguides, the silicon photonics chip 301 is configured to carry electrical current to transmit electrical power to the optical components. In some examples, the silicon photonics chip 301 may include electrical interfaces such as exposed metal pads to deliver electrical current to the optical components. The material properties of the silicon photonics chip 301 provide heat spreading benefits for heat generating optical components. The silicon photonics chip 301 may include thermal interfaces to transfer the heat out of the optical components to improve thermal performance of the LiDAR system.

The integrated module 380 includes an optical source 320 to emit an optical beam. The optical source may be an FMCW optical source. For example, the optical source may be an FMCW laser. In some embodiments, the optical source 320 may be disposed at the first layer 311, as illustrated in FIG. 3A. As an example, the integrated module 380 may include an optical lens (not shown) between the optical source 320 and the silicon photonics chip 301 to focus the optical beam into an input port of the silicon photonics chip 301. As another example, the integrated module 380 may include an optical lens (not shown) between the silicon photonics chip 301 and folding optics 322 to direct the optical beam from an output port of the silicon photonics chip 301 to the folding optics 322. In some other embodiments, the optical source 320 may be disposed at the second layer 312, or be embedded inside the silicon photonics chip 301, which will be discussed below.

In some examples, the folding optics 322 may include a pair of folding mirrors (not shown). One folding mirror may be disposed at the first layer, which may receive the optical beam from the output port of the silicon photonics chip 301 and change the direction of the optical beam from a horizontal direction to a vertical direction. The other folding mirror may be disposed at the second layer 312, which may receive the incoming optical beam from the output port of the silicon photonics chip 301 and change the direction of the outgoing optical beam from the vertical direction back to a horizontal direction opposite to the incoming beam. In some examples, the folding optics 322 may include optical waveguides and/or optical fibers to receive the optical beam from the first layer 311 and transmit the optical beam to the second layer 312.

By directly mounting the second layer 312 over the first layer 311, the overall volume consumed by the integrated module 380 can be contained within the XY form factor of the silicon photonics chip 301. In this fashion, the overall mechanical volume consumed by the integrated module 380 of the LiDAR system is reduced. In addition, electrical power transmission is more efficient, and the thermal performance of the LiDAR system is also improved.

FIG. 3B is a diagram 300b illustrating a top view of the example of the integrated module 380 of the LiDAR system in FIG. 3A according to embodiments of the present disclosure. As discussed above, the silicon photonics chip 301 may include different interfaces, e.g., mechanical interfaces, thermal interfaces, electrical interfaces and/or optical interfaces, to couple the silicon photonics chip 301 to the one or more optical components 330. In some examples, the silicon photonics chip 301 may include mechanical interfaces 334 (e.g., 334A, 334B) to precisely align the optical components. As an example, the mechanical interfaces may include one or more fiducial markers 334A to align the one or more optical components precisely, e.g., aligning the one or more optical components to an optical axis, to predetermined precise locations. As another example, the mechanical interfaces may include one or more etched features 334B to align the one or more optical components precisely, which will be discussed in FIG. 3C.

FIG. 3C a diagram 300c illustrating a cross section view of an example of an optical component 330 in the integrated module 380 of the LiDAR system in FIG. 3A according to embodiments of the present disclosure. Referring to FIG. 3C, the silicon photonics chip 301 may include mechanical interfaces such as fiducial markers 334A and etched features 334B to precisely align the optical components 330. As another example of the mechanical interfaces, etched features 334B may be directly etched on the silicon photonics chip 301 for precision alignment. The etched features 334B may include etched trenches, marks, recissions, etc.

The silicon photonics chip 301 may include thermal interfaces 335, as illustrated in FIG. 3C. The material properties of the silicon photonics chip 301 provide heat spreading benefits for heat generating optical components. The silicon photonics chip 301 may include thermal interfaces 335 to transfer the heat out of the optical components 330 to improve thermal performance of the integrated module 380. In some examples, the thermal interfaces 335 may include high thermal conductivity materials, high thermal conductivity epoxy, or high thermal conductivity soldering materials.

Referring to FIG. 3C, the silicon photonics chip 301 may include electrical interfaces 336. As an example, the electrical interfaces 336 may include exposed metal pads to deliver electrical current to the optical components 330 which need electric power. As discussed above, the silicon photonics chip 301 may be coupled to the electric power source 309. Electric circuits may be printed on the silicon photonics chip 301 to transmit the electric power by the electric circuit. The electrical interfaces 336 including exposed metal pads may be connected to the electric circuit to deliver electrical current to the optical components 330.

In some examples, the second layer 312 may include electrical components (e.g., a circuit, a processor), and/or mechanical components (e.g., sub-mounts) in addition to the optical components 330. The second layer may further include one or more sub-mounts 332 for some of the optical components 330. The one or more sub-mounts 332 may be used to precisely adjust the height or positions of some of the optical components 330. As an example, the one or more sub-mounts 332 may be automatically controlled and adjusted by a processor (not shown).

FIG. 3D is a diagram 300d illustrating a side view of another example integrated module 380d of a LiDAR system according to embodiments of the present disclosure. The integrated module 380d is similar to the integrated module 380 as described in connection with FIGS. 3A-3C, except the integrated module 380d includes a temperature control plate 340 disposed at a bottom of the silicon photonics chip 301. The temperature control plate 340 is configured to control a temperature of the silicon photonics chip 301 and the one or more optical components 330. Due to the thermal properties of the silicon photonics chip 301, the heat from the heat generating optical components 330 at the second layer 312 may be transferred to the silicon photonics chip 301, then further transferred from the silicon photonics chip 301 to the temperature control plate 340.

FIG. 3E is a diagram 300e illustrating a side view of yet another example of an integrated module 308e of a LiDAR system according to embodiments of the present disclosure. The integrated module 380e is similar to the integrated module 380 as described in connection with FIGS. 3A-3C. However, the optical source 320 is disposed at the second layer 312 in integrated module 380e.

In some examples, the optical source 320 is disposed on top of the silicon photonics chip 301 at the second layer 312. The integrated module 380e may further include an optical interface 338 to couple the optical beam from the optical source 320 vertically down into the silicon photonics chip 301. The optical interface 338 may have a high optical coupling efficiency due to the direct coupling of the optical beam from the second layer 312 into the first layer 311. In some examples, the optical source may be embedded inside the silicon photonics chip (not shown) to further reduce the overall mechanical volume of the integrated module.

In some examples, the integrated module 380, 390d, or 380e may further include a signal processor 370 disposed on top of the silicon photonics chip 301 at the second layer 312, as illustrated in FIG. 3E. The signal processor 370 may be configured to process the target return signal and the LO signal to generate the beat frequency to extract range or velocity information related to the target. The signal processor 370 may include a signal processing unit 112 as described in connection with FIG. 1. The signal processor 370 may then generate a 3D point cloud with information about range and velocity of points in the environment. The signal processor 370 may overlay a 3D point cloud data with the image data to determine velocity and distance of the target in the surrounding area.

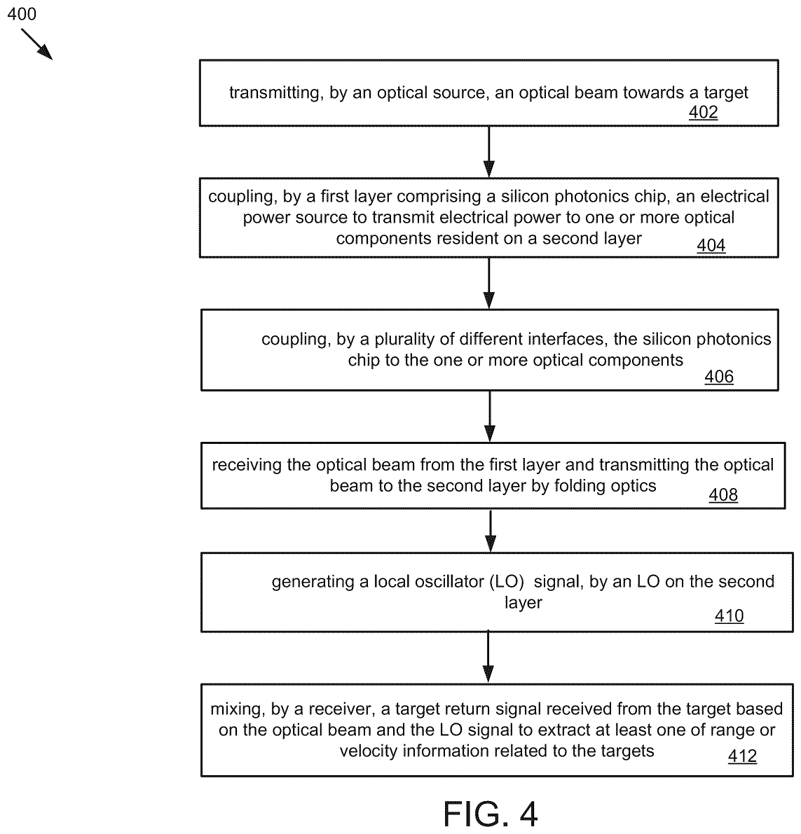

FIG. 4 is a flow diagram illustrating an example of a method of operating the integrated module of the LiDAR system according to embodiments of the present disclosure. Referring to FIG. 4, at block 402, a first layer comprising a silicon photonics chip couples an electrical power source to transmit electrical power to one or more optical components resident on a second layer, where the second layer disposed directly over the first layer. Δt block 406, a plurality of different interfaces couples the silicon photonics chip to the one or more optical components.

At block 408, folding optics receives the optical beam from the first layer and transmits the optical beam to the second layer. At block 410, an LO on the second layer generates an LO signal. At block 412, a receiver mixes a target return signal received from the target based on the optical beam and the LO signal to extract at least one of range or velocity information related to the target.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the present embodiments, including what is described in the Abstract, is not intended to be exhaustive or to limit the present embodiments to the precise forms disclosed. While specific implementations of, and examples for, the present embodiments are described herein for illustrative purposes, various equivalent modifications are possible within the scope of the present embodiments, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A frequency modulated continuous wave (FMCW) light detection and ranging (LiDAR) system, the FMCW LiDAR system comprising:
an optical source to transmit an optical beam towards a target;
a first layer comprising:
a silicon photonics chip coupled to an electrical power source to transmit electrical power to one or more optical components resident on a second layer; and
a plurality of different interfaces to couple the silicon photonics chip to the one or more optical components;
folding optics to receive the optical beam from the first layer and transmit the optical beam to the second layer; and
the second layer disposed directly over the first layer, the second layer comprising:
the one or more optical components comprising:
a local oscillator (LO) to general an LO signal;
a receiver to mix a target return signal received from the target based on the optical beam and the LO signal to extract at least one of range or velocity information related to the target.

2. The FMCW LiDAR system of claim 1, wherein the plurality of different interfaces includes one or more mechanical interfaces.

3. The FMCW LiDAR system of claim 2, wherein the one or more mechanical interfaces comprises etched features to align the one or more optical components.

4. The FMCW LiDAR system of claim 2, wherein the one or more mechanical interfaces comprises one or more fiducial markers to align the one or more optical components.

5. The FMCW LiDAR system of claim 1, wherein the plurality of different interfaces includes one or more electrical interfaces to transmit the electrical power to the one or more optical components.

6. The FMCW LiDAR system of claim 1, wherein the plurality of different interfaces includes one or more thermal interfaces to transfer heat from the one or more optical components to the silicon photonics chip.

7. The FMCW LiDAR system of claim 6, wherein the one or more thermal interfaces comprises high thermal conductivity materials.

8. The FMCW LiDAR system of claim 1, wherein the folding optics comprises folding mirrors.

9. The FMCW LiDAR system of claim 1, wherein the folding optics comprises optical waveguides or fiber optics.

10. The FMCW LiDAR system of claim 1, wherein the second layer further comprises a signal processor to process the target return signal and the LO signal.

11. The FMCW LiDAR system of claim 1, further comprising a temperature control plate disposed at a bottom of the silicon photonics chip to control a temperature of the silicon photonics chip and the one or more optical components, and wherein the silicon photonics chip transfers heat from the first layer to the temperature control plate.

12. The FMCW LiDAR system of claim 1, further comprising a sub-mount to adjust a height of at least one of the one or more optical components.

13. A method of frequency modulated continuous wave (FMCW) light detection and ranging (LiDAR), comprising:
transmitting, by an optical source, an optical beam towards a target;
coupling, by a first layer comprising a silicon photonics chip, an electrical power source to transmit electrical power to one or more optical components resident on a second layer, wherein the second layer disposed directly over the first layer;
coupling, by a plurality of different interfaces, the silicon photonics chip to the one or more optical components;
receiving, by folding optics, the optical beam from the first layer;
transmitting, by the folding optics, the optical beam to the second layer;
generating a local oscillator (LO) signal, by an LO on the second layer; and
mixing, by a receiver, a target return signal received from the target based on the optical beam and the LO signal to extract at least one of range or velocity information related to the target.

14. The method of claim 13, wherein the plurality of different interfaces includes one or more mechanical interfaces.

15. The method of claim 13, wherein the plurality of different interfaces includes one or more electrical interfaces to transmit the electrical power to the one or more optical components.

16. The method of claim 13, wherein the plurality of different interfaces includes one or more thermal interfaces to transfer heat from the one or more optical components to the silicon photonics chip.

17. The method of claim 13, wherein the folding optics comprises folding mirrors.

18. The method of claim 13, wherein the folding optics comprises optical waveguides or fiber optics.

19. The method of claim 13, wherein the second layer further comprises a signal processor, the method further comprising:
processing, by the signal processor, the target return signal and the LO signal to generate a beat signal to extract the at least one of range or velocity information related to the target.

20. The method of claim 13, further comprising:
controlling a temperature of the silicon photonics chip and the one or more optical components by a temperature control plate disposed at a bottom of the silicon photonics chip; and
transferring, by the silicon photonics chip, heat from the first layer to the temperature control plate.
